(19) United States
(12) Patent Application Publication
(10) Pub. No.: US 2023/0231429 A1
(43) Pub. Date: Jul. 20, 2023

(54) SHAPED MAGNET STRUCTURES FOR PERMANENT MAGNET SYNCHRONOUS MACHINES AND METHOD OF MAKING

(71) Applicant: Steering Solutions IP Holding Corporation, Saginaw, MI (US)

(72) Inventors: Alejandro Pina Ortega, Saginaw, MI (US); Subhra Paul, Saginaw, MI (US)

(21) Appl. No.: 17/578,205

(22) Filed: Jan. 18, 2022

(51) Int. Cl. H02K 1/276; H02K 15/03; H02K 1/28

(52) U.S. Cl. CPC H02K 1/2766; H02K 15/03; H02K 1/28; H02K 2213/03

(57) ABSTRACT

A rotor core includes a magnet pocket defined by the rotor core and extending longitudinally in an axial direction of the rotor core. The rotor core also includes a magnet structure disposed within the magnet pocket and extending transversely in a radial direction and/or circumferential direction of the rotor core to define a magnet width, the magnet structure extending longitudinally in the axial direction of the rotor core, wherein the magnet structure has a varied axial length.

### TECHNICAL FIELD

This disclosure relates to an electric motor and, in particular, to a shaped magnet structure for permanent magnet synchronous machines, as well as a method for making such shaped magnet structures.

### BACKGROUND

Electric motors are used in a wide range of applications to convert electrical energy into mechanical rotation. Electric motors typically include a stator and a rotor. The stator generates a magnetic field via application of current that is applied as torque on the rotor, thus causing it to rotate. Stators can generate the magnetic field through either direct current (DC) or alternating current (AC) configurations. The magnetic field both attracts and repels the rotor to generate torque to cause it to rotate.

Electric machines may have specific requirements to operate with low noise and vibration. Some sources of noise, vibration, or harshness in the electric machine may be cogging torque, torque ripple, and electromagnetic radial forces in addition to other aerodynamic or mechanical sources. An electric machine with high torque density generally has higher potential for noise and vibration that may be viewed as unacceptable. Permanent magnet synchronous motors (PMSMs) are widely used in industry applications because of their high torque density. This technology has been implemented in electric power steering (EPS) systems in the pursuit of actuators with fast dynamic response, small packaging and fuel savings to meet stringent automotive requirements. The variations of PMSMs mostly found in EPS systems are those with permanent magnets mounted on the rotor surface and those with the magnets buried or embedded in the rotor. Prior techniques to reduce pulsating torque (cogging and ripple) from a design standpoint include magnet pole shaping in surface mounted permanent magnet motors, rotor lamination shaping in interior permanent magnet motors, and skewing either the stator or the rotor.

Interior permanent magnet machines use rectangular blocks to completely fill the pockets defined in the rotor core which reduces manufacturing complexity and saves magnet material when compared to rotor surface mounted magnet type machines. The main drawback of such configurations is the harmonic content that must be addressed by other means when low pulsating torque is required.

In general, different methods have been employed to mitigate the noise and vibrations from the electric machine, however as demands for higher torque density increases, new strategies or configurations to mitigate noise and vibrations from the electric machine must be developed.

### SUMMARY

According to one aspect of the disclosure, a rotor core includes a magnet pocket defined by the rotor core and extending longitudinally in an axial direction of the rotor core. The rotor core also includes a magnet structure disposed within the magnet pocket and extending transversely in a radial direction and/or circumferential direction of the rotor core to define a magnet width, the magnet structure extending longitudinally in the axial direction of the rotor core, wherein the magnet structure has a varied axial length.

According to another aspect of the disclosure, a magnet structure for an interior permanent magnet electric machine is provided. The magnet structure includes a first axial end. The magnet structure also includes a second axial end, wherein at least one of the first axial end and the second axial end is shaped to define a varied axial length of the magnet structure.

According to yet another aspect of the disclosure, a method of making a rotor core for an interior permanent magnet electric machine is provided. The method includes stacking a plurality of magnet segments to define a magnet structure. The method also includes shaping at least one of the plurality of magnet segments to define a varied axial length of the magnet structure. The method further includes installing the magnet structure in a magnet pocket defined by the rotor core.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a perspective view of a rotor core having a plurality of magnet structures disposed within respective magnet pockets of the rotor core;

FIG. 2 is a magnet structure for the rotor core according to one aspect of the disclosure;

FIGS. 3-6 illustrate various magnet structures having longitudinally extending magnet segments according to multiple aspects of the disclosure;

FIG. 7 illustrates a magnet structure having transversely extending magnet segments according to another aspect of the disclosure;

FIG. 8 illustrates a magnet structure having a combination of longitudinally and transversely extending magnet segments according to another aspect of the disclosure; and

FIG. 9 illustrates an example magnet structure and a filler material disposed within a magnet pocket of the rotor core.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, electric motors are used in a wide range of applications to convert electrical energy into mechanical rotation. Electric motors typically include a stator and a rotor. The stator generates a magnetic field via application of current that is applied as torque on the rotor causing it to rotate. Stators can generate the magnetic field through either direct current (DC) or alternating current (AC) configurations. The magnetic field both attracts and repels the rotor to generate torque and cause it to rotate.

Electric motors include poles in the form of permanent magnets or bundled wire in the stator. The number of poles generally corresponds to the torque output, wherein a greater number of poles generates a larger torque. Electric motors further include slots, which dictate the number of phases of power available. In applications requiring a larger amount of torque and a variety of phases, such as in the automobile industry, there are generally a larger amount of both poles and slots. For example, electric motors with 12 slots and 10 poles have been shown to have favorable characteristics over conventionally used electric motors with 12 slots and 8 poles or 9 slots and 6 poles. More specifically, electric motors with 12 slots and 10 poles generally have lower torque ripple, higher power/torque densities, and lower cogging torque even without skewing. These attributes can result in lower cost and smaller packaging compared to other configurations. However, the low order mode shape for deflection with this electric motor makes it more challenging with respect to noise, vibration, and harshness (NVH). Various methods have been proposed to address this issue including electromagnetic and structural solutions.

Electromagnetic solutions usually strive for reduction of radial forces in the machine or the elimination of specific harmonics that contribute to low order mode shape. However, these solutions usually have a negative effect to the magnetic performance of the motor including negative impacts to the average torque and the cogging torque. Structural solutions, on the other hand, have minimal effect on the electromagnetic performance of the motor. Physical parts or features are implemented to dampen the vibration. Various implementations have been proposed including profiling the outer circumference of the stator, using spring devices as a damper between the stator and the housing, and additional implementations. However, these structural solutions generally include increases in cost, weight, and complexity of the electric motor for only limited reductions in NVH.

In operation, the electric motor assembly may be used in a vehicle, such as a car, truck, sport utility vehicle, crossover, mini-van, marine craft, aircraft, all-terrain vehicle, recreational vehicle, or other suitable vehicles. The vehicle may include any suitable propulsion system including an internal combustion engine, one or more electric motors (e.g., an electric vehicle), one or more fuel cells, a hybrid (e.g., a hybrid vehicle) propulsion system comprising a combination of an internal combustion engine, one or more electric motors, and/or any other suitable propulsion system. The vehicle may further include a steering system that translates a steering input to an output and ultimately cause the vehicle to turn. The electric motor assembly described herein may be used in a number of automotive applications, such as in the steering system or the propulsion system. For example, the electric motor may be utilized in a steer-by-wire system, a steering assist assembly, autonomous driving steering, and other applications. In some embodiments, the electric motor may be configured as an AC or DC electric motor and may further be configured for a reversed flow of current for providing electric generator functionality. In some embodiments, the electric motor assembly could also be utilized in other contexts.

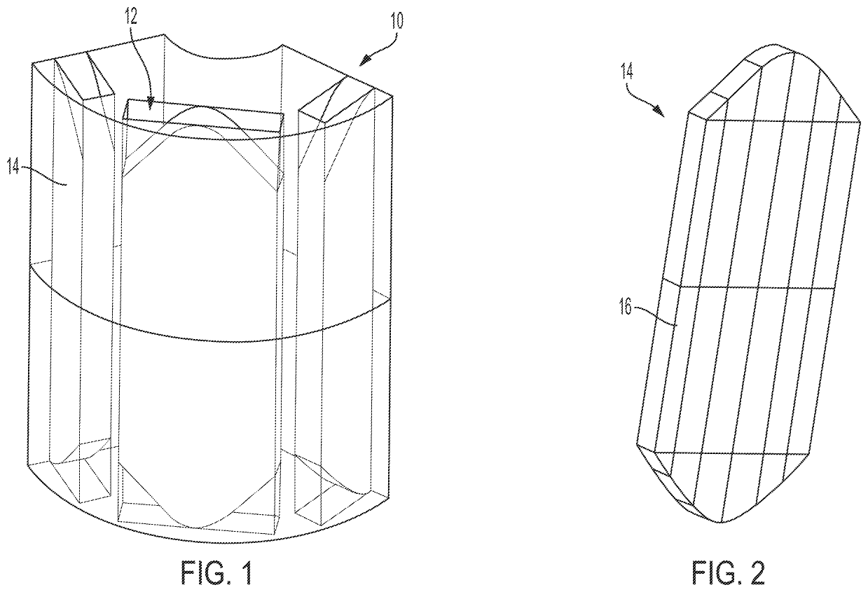

FIG. 1 generally illustrates a portion of a rotor 10 (or a rotor core), which is a portion of the overall electric motor assembly, as described above, and is located proximate a stator (not shown). The rotor 10 may be integral with or otherwise attached to a component of an automobile, for example, a drive shaft of a propulsion system, or a shaft, gear or other component of a steering assist system.

The rotor 10 extends about an axis A in what is referred to herein as an axial or longitudinal direction. The rotor also extends radially outward away from axis A and circumferentially. The rotor 10 defines a plurality of magnet pockets 12 which are substantially rectangular in shape. The magnet pockets 12 also extend axially in the longitudinal direction and in a direction that is perpendicular to the longitudinal direction, which is referred to as a transverse direction. The transverse direction is therefore substantially common to the circumferential direction and/or radial direction described above. As shown, each of the magnet pockets 12 has a respective magnet structure 14 disposed—or installed—therein. The magnet structures 14 may be formed of a single magnet segment or a plurality of magnet segments, as described in detail herein.

Regardless of the number of magnet segments utilized to form the magnet structures 14, the magnet structures 14 have an overall shape that extends axially in the longitudinal direction, as well as transversely in the circumferential direction and/or radial direction. The magnet structures 14 have a thickness that allows it to be installed within the magnet pockets 12. However, the overall shape of the magnet structures 14 have a varied axial length at one or both ends thereof. The term varied axial length refers to the lack of a common axial length of the magnet structure 14 that is not inadvertently due to manufacturing tolerances and processes. In other words, one or both ends have portions thereof that do not extend axially to a common flat end, as is done with traditional rectangular magnets utilized in rotors of such electric machines.

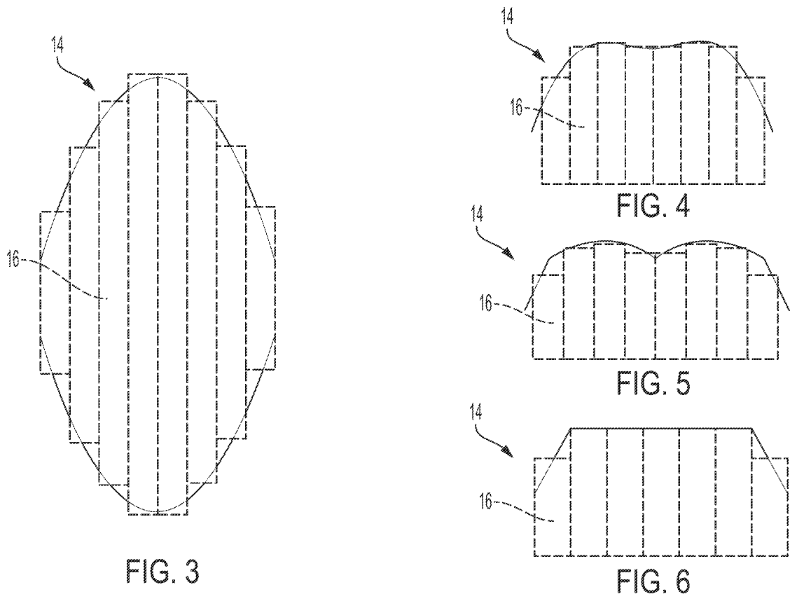

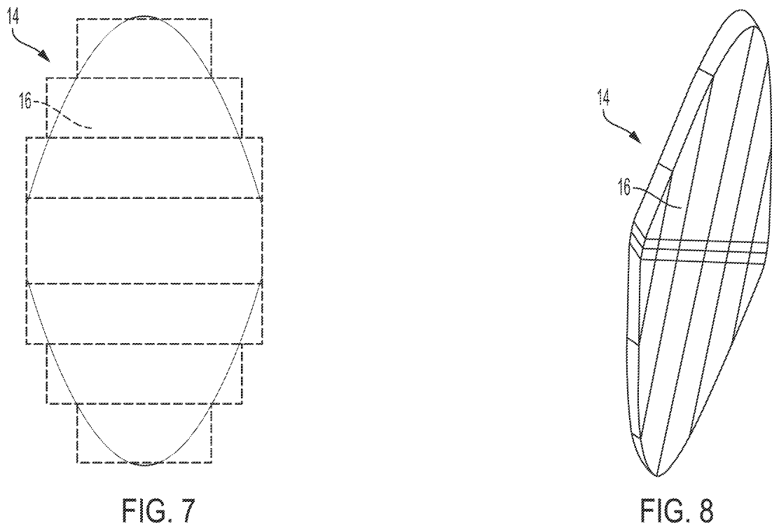

Referring now to FIG. 2, the magnet structure 14 may be formed of a plurality of magnet segments 16, which are smaller magnets that are stacked together to form the overall magnet structure 14. In embodiments having a plurality of magnet segments 16, the stacking formation of the magnet segments 16 may be done in any conceivable manner. General examples include stacking axially extending magnet segments 16 in a transverse manner, as shown in FIGS. 3-6, or stacking transversely extending magnet segments 16 in a longitudinal manner, as shown in FIG. 7. Furthermore, the magnet segments 16 may be stacked with a combination of longitudinal and transverse arrangements, as shown in FIGS. 2 and 8, for example. In embodiments where axially extending magnet segments 16 are stacked in a transverse manner, at least one of the magnet segments 16 have an axial length that is different than an axial length of at least one other magnet segment 16. In embodiments where transversely extending magnet segments 16 are stacked in an axial manner, at least one of the magnet segments 16 have a transverse width that is different than a transverse width of at least one other magnet segment 16. It is to be appreciated that the illustrated stacking arrangements are merely examples and are not limiting of the numerous possibilities covered by the embodiments of the invention described herein.

Referring to FIGS. 2-7, examples of different shapes that may be employed for the magnet structures 14 are shown. As illustrated, all of the shapes have at least one end of the magnet structure 14 that defines a varied axial length (i.e., not rectangular). Each of the illustrated examples of the magnet structure 14 is axially shaped to approximate a trigonometric function. Axially varied ends of the magnet structure 14 creates smoother or more sinusoidal magnetic flux density in the air gap than conventional square or rectangular magnets, thereby reducing spatial harmonic content of flux density that which directly results in minimized torque pulsations. The illustrated examples are not limiting of the shapes that may be used for the magnet structures 14.

The magnet structures 14 may be axially shaped in the form of a partially sinusoidal structure (FIG. 2) or a completely sinusoidal structure (FIG. 7) at the edges of an otherwise rectangular block, for example. By way of further example, axial shaping can be done to form a sinusoidal plus third harmonic shape (FIG. 4), a triangular plus third harmonic shape (FIG. 5), or a trapezoidal shape (FIG. 6).

The magnet structures 14 can be inserted into any type of IPM configuration, such as flat, V-shape, delta or spoke type, for example. As described above, the magnet structures 14 may be formed of a single magnet segment or a plurality of magnet segments 16. In embodiments with a plurality of magnet segments 16, the segments are sorted and placed (e.g., stacked) such that they approximate the desired trigonometric function. This segmentation reduces magnet material waste, limits eddy currents in magnet material, as well as allows rotor step skewing, if needed. It is to be further understood that shaping or magnet stacking may be done to provide transverse variation in addition to, or as an alternative to, the axial variation disclosed herein.

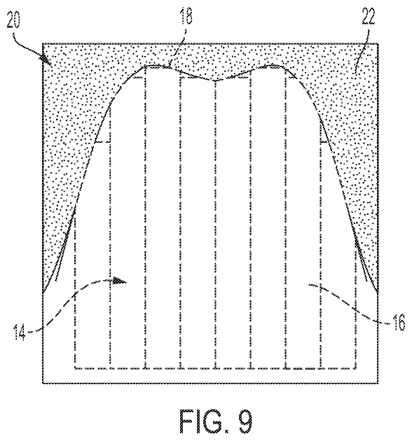

Referring now to FIG. 9, a portion (i.e., an end) of the magnet structure 14 is shown in an installed condition within the magnet pocket 12 of the rotor 10. As shown, the varied axial shape at the end 18 proximate an end of the magnet pocket 12 results in an unfilled portion 20 in the magnet pocket 12. The unfilled portion 20 may be left unfilled as a void in some embodiments. Alternatively, the unfilled portion 20 may be filled with a filler material 22. The filler material 22 may be a magnetic material or a non-magnetic material. For example, the filler material 22 filler material is a plastic injected material in some embodiments. In other embodiments, the filler material 22 is an injected molded low-residual-flux material, such as ferrite or an intermetallic compound samarium-iron (SmFe), for example. The filler material 22 is different than the material of the magnet structure 14. The magnet structure 14 may be formed of any suitable rare earth material, such as NdFeB or SmCo, for example. The preceding examples of materials for the magnet structure 14 and the filler material 22 are non-limiting of other contemplated materials. The addition of the filler material 22 may boost torque density.

In addition to the actual structural embodiments disclosed herein, a method of making a rotor core for an interior permanent magnet electric machine is disclosed. The method includes stacking the plurality of magnet segments 16 to define the magnet structure 14, then shaping at least one of the plurality of magnet segments 16 to define a varied axial length of the magnet structure 14. The magnet structure 14 may then be installed in the magnet pocket 12 defined by the rotor 10. In some embodiments, after installing the magnet structure 14 in the magnet pocket 12, the filler material 22 is provided in the unfilled portion 20 of the magnet pocket 12.

The disclosed embodiments reduce the pulsating torque of an interior or spoke-type permanent magnet synchronous machine (PMSM) with the axial magnet shaping described in detail herein by minimizing harmonic content in back EMF and cogging torque.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

The above-described embodiments, implementations, and aspects have been described in order to allow easy understanding of the present disclosure and do not limit the present disclosure. On the contrary, the disclosure is intended to cover various modifications and equivalent arrangements included within the scope of the appended claims, which scope is to be accorded the broadest interpretation to encompass all such modifications and equivalent structure as is permitted under the law.

What is claimed is:

1. A rotor core comprising:
a magnet pocket defined by the rotor core and extending longitudinally in an axial direction of the rotor core; and
a magnet structure disposed within the magnet pocket and extending transversely in a radial direction and/or circumferential direction of the rotor core to define a magnet width, the magnet structure extending longitudinally in the axial direction of the rotor core, wherein the magnet structure has a varied axial length.

2. The rotor core of claim 1, wherein the magnet structure comprises a plurality of magnet segments which are stacked together to form the magnet structure.

3. The rotor core of claim 2, wherein the plurality of magnet segments extend fully in the longitudinal direction of the magnet structure and are transversely stacked in the radial direction and/or the circumferential direction of the rotor core.

4. The rotor core of claim 3, wherein at least one of the plurality of magnet segments has a segment axial length that is different than that of at least one of the other plurality of magnet segments.

5. The rotor core of claim 3, wherein each of the plurality of magnet segments has a segment axial length that is different than that of all of the other plurality of magnet segments.

6. The rotor core of claim 2, wherein the plurality of magnet segments extend fully transversely in the radial direction and/or the circumferential direction of the magnet structure and are longitudinally stacked in the axial direction of the rotor core.

7. The rotor core of claim 6, wherein at least one of the plurality of magnet segments has a segment width that is different than that of at least one of the other plurality of magnet segments.

8. The rotor core of claim 6, wherein each of the plurality of magnet segments has a segment width that is different than that of all of the other plurality of magnet segments.

9. The rotor core of claim 2, wherein the plurality of magnet segments are a combination of transversely stacked magnet segments stacked in the radial direction and/or the circumferential direction of the rotor core and longitudinally stacked magnet segments in the axial direction of the rotor core.

10. The rotor core of claim 1, wherein an unfilled portion of the magnet pocket is defined in an installed position of the magnet structure within the magnet pocket.

11. The rotor core of claim 10, further comprising a filler material disposed in the unfilled portion of the magnet pocket.

12. The rotor core of claim 11, wherein the filler material is a plastic injected material.

13. The rotor core of claim 11, wherein the filler material is an injected molded low-residual-flux material.

14. The rotor core of claim 11, wherein the filler material is a magnetic material.

15. The rotor core of claim 11, wherein the filler material is a non-magnetic material.

16. The rotor core of claim 1, wherein the magnet structure consists of a single magnet segment.

17. A magnet structure for an interior permanent magnet electric machine, the magnet structure comprising:
a first axial end; and
a second axial end, wherein at least one of the first axial end and the second axial end is shaped to define a varied axial length of the magnet structure.

18. The magnet structure of claim 17, wherein the magnet structure is formed with a plurality of stacked magnet segments.

19. A method of making a rotor core for an interior permanent magnet electric machine, the method comprising:
stacking a plurality of magnet segments to define a magnet structure;
shaping at least one of the plurality of magnet segments to define a varied axial length of the magnet structure; and
installing the magnet structure in a magnet pocket defined by the rotor core.

20. The method of claim 19, wherein installing the magnet structure in the magnet pocket defines an unfilled portion of the magnet pocket, the method further comprising disposing a filler material in the unfilled portion of the magnet pocket.
